(19) United States
(12) Patent Application Publication
(10) Pub. No.: US 2026/0259756 A1
(43) Pub. Date: Sep. 3, 2026

(54) SECURE VIRTUALIZATION FOR THIRD PARTY GRAPHICS DRIVERS

(71) Applicant: Google LLC, Mountain View, CA (US)

(72) Inventors: Idan Barda Raiter, Glendale, CA (US); Gregory Schlomoff, Berkeley, CA (US); Kaiyi Li, San Francisco, CA (US); Gurchetan Singh, Mountain View, CA (US)

(21) Appl. No.: 19/163,825

(22) PCT Filed: Apr. 9, 2024
(86) PCT No.: PCT/US2024/023722

§ 371 Date: Sep. 9, 2025

Related U.S. Application Data
(60) Provisional application No. 63/495,151, filed on Apr. 10, 2023.

(51) Int. Cl. G06F 9/455

(52) U.S. Cl. CPC G06F 9/45545; G06F 9/45558; G06F 2009/45583; G06F 2009/45587

(57) ABSTRACT

In general, techniques are described by which to enable secure virtualization for third party graphics drivers. A computing device comprising a memory and processing circuitry may be configured to perform the techniques. The memory may store a host operating system. The processing circuitry may execute the host operating system, which is configured to initiate execution of a main process that emulates a guest operating system to support execution of an application native to the guest operating system. The main process may initiate execution of a graphics rendering process. The main process may next, responsive to initiating execution of the graphics rendering process, perform a memory validation to obtain memory mapping information that identifies memory that is available for mapping between the main process and the graphics rendering process. The main process may configure the main process to support the mapping of the memory.

### BACKGROUND

Computing devices may support (or, in other words, host-which may result in such computing devices being referred to as “host computing devices”) virtual environments in which virtual instances (such as so-called virtual machines) execute as separate processes that share underlying computing hardware (e.g., memory, central processing units, interfaces) of the computing device in a restricted manner that limits interactions between virtual machines. Due to the limits provided by the virtual environments to restrict virtual machine interactions, each virtual machine may appear to both other virtual machines and other physical computing devices as distinctly different computing devices (even when virtual machines share the same underlying computing hardware). Such restrictions provided by the virtual environment may provide increased security (as one maliciously configured virtual machine is restricted from directly accessing other virtual machines), improved reliability for the host computing device (given that failure of one virtual machine may not impact the underlying host computing device), and otherwise allow for increased utilization of available computing resources while reducing the above noted security concerns.

In some instances, the virtual environment may allow for a virtual machine to execute a guest operating system that is separate from a host operating system executed by the host computing device. The guest operating system may allow for execution of different applications that are unavailable for execution by the host operating system. These different applications may include various video games that are optimized for the guest operating system. The virtual machine may therefore emulate (and may be referred to as an “emulator”) the native hardware architecture required for executing the guest operating system (along with the video games) and thereby enable the video games to be executed within a different hardware architecture executing the host operating system.

Although virtual machines may be restricted via the virtual environment, there are still various ways malicious applications (including the video games) may impact the underlying host computing device. Video games may, for example, gain access to graphical processing units (GPUs) to render content, which may allow malicious video games to gain access to the underlying hardware supporting execution of the host operating system for malicious or unauthorized purposes (e.g., using the GPU of the host computing device for unauthorized mining of cryptocurrencies). Attempts to address the security concerns with malicious video games executed in emulated virtual environments may result in a number of unaligned security measures that may severely reduce the ability of emulated virtual environments to support execution of legitimate video games (or other legitimate applications), especially when the host operating system utilizes third party graphics drivers (meaning, graphics drivers not developed by the developer of the host operating system).

### SUMMARY

In general, techniques of this disclosure may enable a host computing device to provide secure virtualization for third party graphics drivers. The host computing device may provide a shim layer that, through experimentation, validates various memory capabilities supported by the underlying graphics processing unit (GPU) and exposed by a corresponding third-party graphics driver (where again, third party refers to graphics drivers not developed by the developer of a host operating system executed by the host computing device). This shim layer may be referred to as a “memory validator,” which spawns multiple processes in separate isolated virtual instances (possibly, virtual machines) and attempts to map memory between the multiple processes so as to accommodate various memory requirements specified for execution of standardized graphics application programming interfaces (APIs), such as OpenGL® and Vulkan®.

These standardized graphics APIs may be developed for a particular hardware architecture and guest operating system in which mapping of memory (e.g., GPU memory) is not required because the hardware architecture and guest operating system do not accommodate concurrent execution of applications to the same extent as the host operating system. For example, a guest operating system for a smartphone, tablet, handheld gaming system, etc. may not require as much security given the controlled nature in which the guest operating system and underlying hardware architecture are generally optimized with respect to each other and control is dictated by the developer of the guest operating system and/or hardware architecture. When a host computing device emulates this hardware architecture for the guest operating system (that implements the standardized graphics API) in the context of third party graphics drivers in which the developer of the guest operating system has little to no control (and thus cannot mandate support for memory mapping), mapping of memory may be difficult and thereby prevent optimized execution of applications that rely on the standardized graphics API.

The memory validator may alleviate some of the difficulties with mapping memory between isolated processes to identify when the standardized graphics APIs can be executed as isolated processes separate from the emulator that executes the guest operating system. This isolation may result in more secure virtualization as the standardized graphics APIs can be executed as a separate graphics rendering process in a more restricted mode that limits the impact of malicious applications on the underlying host operating system and/or host computing device. In this respect, the memory validator may identify memory mapping information supported by the third party graphics driver (and underlying GPU) that facilitates execution of the standardized graphics API as a separate graphics rendering process having restrictions that may reduce security risks.

Accordingly, the described techniques may improve operation of the host computing device itself. That is, the host computing device may, by way of executing the memory validator, identify when the graphics rendering process may be executed as an isolated restricted process that potentially reduces security risks that may occur should the guest operating system allow execution of malicious applications. By executing the graphics rendering process, the host computing device may also facilitate more optimized execution (in terms of latency, computing resource utilization-such as processor cycles, GPU cycles, memory, memory bandwidth, etc., and associated power consumption) by way of potential improvements provided by the standardized graphics APIs. When the memory validator identifies failures with respect to required memory mapping between isolated processes, the guest operating system may default to execution of the graphics rendering process without as much isolation between the guest operating system, the graphics rendering process, and to some extent the host operating system/hardware, thereby still facilitating execution of the application.

In one example, various aspects of the techniques are directed to a method comprising: initiating, by a host operating system executed by a computing device, execution of a main process that emulates a guest operating system to support execution of an application native to the guest operating system; initiating, by the main process, execution of a graphics rendering process separate from the main process, the graphics rendering process configured to handle graphics rendering on behalf of the main process; responsive to initiating execution of the graphics rendering process, performing, by the main process, a memory validation to obtain memory mapping information that identifies memory within the computing device that is available for mapping between the main process and the graphics rendering process; and configuring, based on the memory mapping information, the main process to support the mapping of the memory between the main process and the graphics rendering process to facilitate execution of a graphical rendering application programming interface used by the application for rendering graphics.

In another example, various aspects of the techniques are directed to a computing device comprising: a memory configured to store a host operating system; and processing circuitry configured to: execute the host operating system, which is configured to initiate execution of a main process that emulates a guest operating system to support execution of an application native to the guest operating system, wherein the main process is configured to: initiate execution of a graphics rendering process separate from the main process, the graphics rendering process configured to handle graphics rendering on behalf of the main process; responsive to initiating execution of the graphics rendering process, perform a memory validation to obtain memory mapping information that identifies memory within the computing device that is available for mapping between the main process and the graphics rendering process; and configure the main process to support the mapping of the memory between the main process and the graphics rendering process to facilitate execution of a graphical rendering application programming interface used by the application for rendering graphics.

In another example, various aspects of the techniques are directed to an apparatus comprising: means for initiating execution of a main process that emulates a guest operating system to support execution of an application native to the guest operating system; means for initiating execution of a graphics rendering process separate from the main process, the graphics rendering process configured to handle graphics rendering on behalf of the main process; responsive to initiating execution of the graphics rendering process, means for performing a memory validation to obtain memory mapping information that identifies memory within the computing device that is available for mapping between the main process and the graphics rendering process; and means for configuring, based on the memory mapping information, the main process to support the mapping of the memory between the main process and the graphics rendering process to facilitate execution of a graphical rendering application programming interface used by the application for rendering graphics.

In another example, various aspects of the techniques are directed to a non-transitory computer-readable storage medium having instructions stored thereon that, when executed, cause one or more processors to: execute a host operating system, which is configured to initiate execution of a main process that emulates a guest operating system to support execution of an application native to the guest operating system, wherein the main process is configured to: initiate execution of a graphics rendering process separate from the main process, the graphics rendering process configured to handle graphics rendering on behalf of the main process; responsive to initiating execution of the graphics rendering process, perform a memory validation to obtain memory mapping information that identifies memory within the computing device that is available for mapping between the main process and the graphics rendering process; and configure the main process to support the mapping of the memory between the main process and the graphics rendering process to facilitate execution of a graphical rendering application programming interface used by the application for rendering graphics.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example host computing device configured to perform various aspects of secure virtualization techniques described in this disclosure.

FIG. 2 is a block diagram illustrating an example host computing device that is configured to secure graphics virtualization in accordance with various aspects of the techniques described in this disclosure.

FIGS. 3A-3C are flowcharts illustrating various examples of how memory mapping may occur in support of the secure virtualization techniques described in this disclosure.

FIGS. 4A-4C are flowcharts illustrating example operation of memory validator in supporting various aspects of the secure virtualization techniques described in this disclosure.

FIG. 5 is a flowchart illustrating example operation of host computing device in performing various aspects of the secure virtualization techniques described in this disclosure.

### DETAILED DESCRIPTION

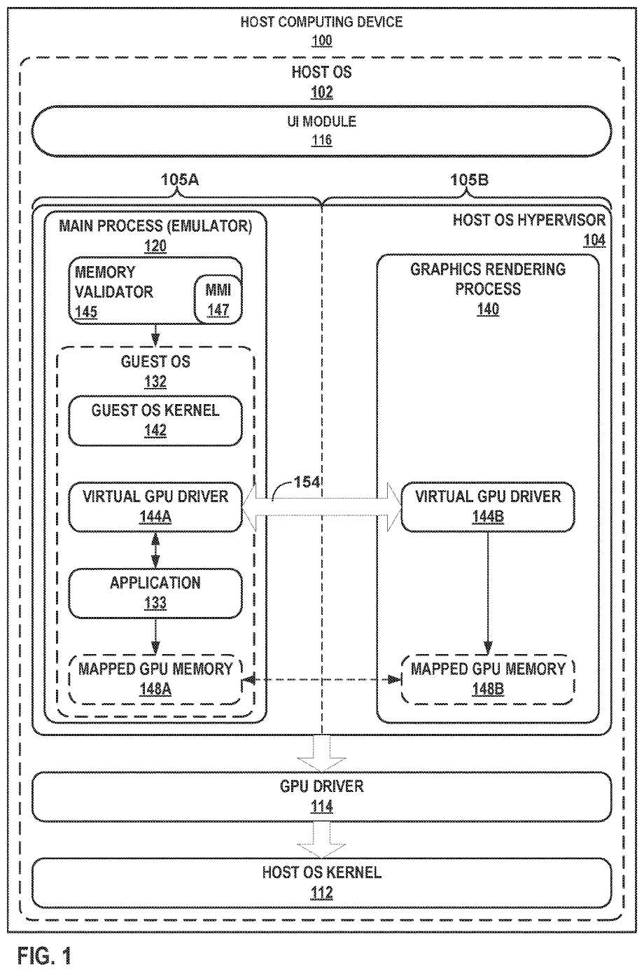

FIG. 1 is a conceptual diagram illustrating an example host computing device configured to perform various aspects of secure virtualization techniques described in this disclosure. A host computing device 100 may represent any type of computing device capable of executing a virtual environment that supports execution of distinct and separate virtual machines via the same underlying hardware of host computing device 100 in an isolated (or, in other words, permission restricted) manner. Examples of host computing device 100 may include an extended reality (XR) headset (which may generally refer to one or more of an augmented reality-AR-headset, a virtual reality-VR-headset, a mixed reality-MR-headset, etc.), smartglasses, a desktop computer, a laptop computer, a smartphone (or other cellular handset), a video game system, a smart television, etc.

As shown in the example of FIG. 1, host computing device 100 may execute a host operating system (OS) 102. Although not shown in the example of FIG. 1 for ease of illustration purposes, host computing device 100 may include processing circuitry (e.g., one or more of a central processing unit—CPU, a field programmable gate array—FPGA, an application specific integrated circuit—ASIC, a display processor, a graphics processing unit—GPU, various controllers including network interface cards—NICs, etc.), storage (e.g., memory, such as caches, random access memory—RAM—including variations thereof, Flash memory, etc.; solid state drives, hard disk drives, and other storage mediums), and other hardware to support execution of host operating system 102.

Host operating system 102 may be referred to as a “host” in the sense that host operating system 102 supports execution of a virtual environment that facilitates hosting of a guest operating system 132. Host operating system 102 may include a host operating system (OS) hypervisor 104 that manages the virtual environment in terms of managing access to the underlying hardware of host computing device 100 by separate and distinct virtual instances 105A and 105B (“virtual instances 105”). While two virtual instances 105 are shown in the example of FIG. 1, host OS hypervisor 104 may manage a single virtual instance or three or more multiple instances. Virtual instances 105 may each represent a separate virtual machine (and as such may be referred to as “virtual machines 105”), in which virtual hardware elements are configured to resemble a separate and distinct computing device.

Host OS hypervisor 104 may, for example, allocate storage from the underlying storage for use solely by each of virtual machines 105, reserve processor cycles of one or more CPUs (or CPU cores) for use by each of virtual machines 105, reserve GPU cycles/pipeline for use by each of virtual machines 105, etc. Host OS hypervisor 104 may then schedule execution of virtual machines 105 via the underlying processing circuitry while maintaining restrictions through permissions that limit interactions between virtual machines 105 and effectively isolate virtual machines 105 from impacting other virtual machines, host operating system 102 and/or host computing device 100. Host OS hypervisor 104 may enforce these restrictions to improve security with respect to virtual machines 105 (from being tampered with by host operating system 102 but also by other virtual machines) and with respect to host operating system 102 and host computing device 100.

Host operating system 102 also includes a host OS kernel 112, which forms the primary interface with which host operating system 102 interfaces with the underlying hardware of host computing device 100. Host OS kernel 112 may operate under less restrictive permissions than other applications, including virtual machines 105. Host OS kernel 112 may operate in kernel space defined by the less restrictive permissions that enable host OS kernel 112 to interface with the underlying hardware of host computing device 100. Host OS kernel 112 may expose an OS application programming interface (API) that most other applications may invoke to gain restricted access to the underlying hardware of host computing device 100. Via this OS API, host OS kernel 112 may support an application space that has limited permissions compared to the kernel space in order to prevent unauthorized access by applications to the underlying hardware of host computing device 100.

In some instances, host OS hypervisor 104 may have less restrictions than even host OS kernel 112 as a result of needing to negotiate directly with the underlying hardware of host computing device 100 to facilitate support of the virtual environment and context switching between virtual machines 105. To illustrate, host OS kernel 112 may not natively allow for mapping of memory (e.g., heaps, queues, etc.) between distinct processes (meaning processes that are not spawned by a parent process and share similar if not the same permissions, but that are distinct and originate from different processing instances having possibly different levels of permissions) such that each process may share a common memory.

Host OS hypervisor 104 may allow such memory mappings in some contexts given the nature of virtualization, which may result in distinct processes (that are related) being executed in different virtual machines 105 (e.g., for purposes of security) needing to access a common memory. Rather than enforce kernel space requirements, host OS hypervisor 104 may optimize this access to a common memory through the memory mapping between distinct processes to facilitate more efficient operation of the virtual environment (which arguably maintains the virtualization as both virtual machines 105 are unaware that such mapped memory is actually shared given that host OS hypervisor 104 maintains this memory mapping abstraction).

In any event, host operating system 102 may also include a GPU driver 114, which may represent a third party GPU driver (and as such may also be referred to as a “third party GPU driver 114”). The term “third party” may denote that GPU driver 114 may be developed by a developer different than the developer of host operating system 102 (which may be considered the so-called “first party”). Given that the hardware architecture of host computing device 100 may support modifications to include third party hardware, such as third party GPUs, host operating system 102 may support extensions to host OS kernel 112 by way of drivers, such as third party GPU driver 114.

Third party GPU driver 114 may expose a graphics API specific to the underlying hardware GPU that facilitates graphics rendering in the specific manner supported by the underlying hardware GPU. Developers may code applications using a different standardized graphics API (such as OpenGL® or Vulkan®), which outputs a command stream to third party GPU driver 114 for translation into function calls supported by host OS kernel 112. The entirety of the standardized graphics API, third party GPU driver 114, and host OS kernel 112 may be referred to as a “graphics software stack.” The graphics software stack may render graphics content for presentation via a user interface (UI).

As further shown in the example of FIG. 1, host operating system 102 may include a UI module 116 that may manage user interactions with host computing device 100. UI module 116 may receive one or more indications of input (e.g., voice input, gesture input, etc.) from a user as the user interacts with a user interface presented by a UI hardware component (often denoted as “UIC”). UI Module 116 may also present graphics content rendered via the graphics software stack for consumption by a user of host computing device 100.

It is assumed, in the example of FIG. 1, that virtual machine 105A is used to execute a main process 120 that emulates a guest operating system (OS) 132 to support execution of an application 133 native to guest OS 132. Guest OS 132 may execute according to a different hardware architecture than the hardware architecture executing host OS 102. This different hardware architecture commonly refers to different processing circuitry architectures, where guest OS 132 may be configured for execution by an Advanced Reduced instruction set computer Machines (ARM®), while host OS 132 may be configured for execution according to a so-called “x86” complex instruction set computer (CISC) processing architecture. There also may be differences between the hardware architectures in terms of supported memory types, amounts of memory, etc.

Main processor 120 may emulate this different hardware architecture (e.g., ARM® architecture) to facilitate execution of guest OS 132, which generates ARM® compliant processing instructions. Main processor 120 may effectively translate the ARM® compliant processing instruction into processing instructions that conform to the hardware architecture of the underlying host computing device 100 (which is assumed to be an x86 hardware architecture in the example of FIG. 1). As such, main process 120 may allow host OS 102 to emulate the ARM® hardware architecture for execution on the x86 hardware architecture (and main process 120 may, as a result, be referred to as “emulator 120”).

Guest OS 132 may include a guest OS kernel 142 that, similar to host OS kernel 112, facilitates a division of permissions between kernel space and application space for guest OS 132, providing an API that can be invoked by application 133 in order to access the virtual hardware represented by virtual machine 105A. Guest OS 132 may also include a virtual GPU driver 144A that represents a standardized graphics API (e.g., Vulkan®) that is promulgated by a standards body (e.g., Khronos Group Inc. for Vulkan®). Virtual GPU driver 144A may represent a user-mode (UM) of the standardized graphics API (which may effectively represent a virtual GPU device).

As noted above, the virtual environment may allow for virtual machine 105A to execute guest operating system 132 that is separate from host operating system 102 executed by host computing device 100. Guest operating system 132 may allow for execution of different applications (e.g., application 133) that are unavailable for execution by host operating system 102. In other words, application 133 is native to guest OS 132 but not natively executable by host OS 102. These different applications may include various video games (and for purposes of illustration application 133 is assumed to be a video game and may be referred to as “video game 133”) that are optimized for guest operating system 132. Virtual machine 105A may therefore emulate (via emulator 120) the native hardware architecture required for executing guest operating system 132 (along with video game 133) and thereby enable video game 133 to be executed within a different hardware architecture (e.g., the x86 hardware architecture) executing host operating system 102.

Although virtual machines 105 may be restricted via the virtual environment enforced by host OS hypervisor 104, there are still various ways malicious applications (including video game 133) may impact the underlying host computing device 100. Video game 133 may, for example, gain access to graphical processing units (GPUs) to render content, which may allow malicious video games to gain access to the underlying hardware supporting execution of host operating system 102 for malicious or unauthorized purposes (e.g., using the GPU of host computing device 100 for unauthorized mining of cryptocurrencies). Attempts to address the security concerns with malicious video games executed in emulated virtual environments may result in a number of unaligned security measures that may severely reduce the ability of emulated virtual environments to support execution of legitimate video games (or other legitimate applications), especially when host operating system 102 utilizes third party graphics driver 114.

That is, virtual GPU driver 144A may require certain types of memory be mapped to support communication with the underlying hardware GPU of host computing device 100. When the developer of guest OS 132 is able to control (or, in other words, dictate) hardware and software requirements for execution of guest OS 132, the developer may control memory mapping requirements in support of virtual GPU driver 144A. However, in the emulated environment (which is another way to refer to the virtual environment that supports emulator 120), the developer of guest OS 132 may not control or otherwise dictate hardware and software requirements with respect to the developer of host OS 102 (which in this context may represent a third party compared to the first party that developed guest OS 132). This lack of control may introduce various security risks given that the developer of the guest OS 132 may have to implement workarounds for this lack of control.

For example, the developer of guest OS 132 may not implement the guest graphical stack in a separate virtual instance given restrictions on mapping memory between different distinct virtual instances. As such, the graphical software stack of guest OS 132 may receive more permissions that would otherwise be granted for the graphical software stack executed in a separate virtual instance (from the virtual instance executing guest OS 132). Malicious video games may therefore exploit these increased permissions provided to the guest OS 132 to introduce possible security risks (e.g., data security, system security, etc.). While various graphics stream validators exist and, when employed, attempt to contain malicious graphics command streams, given the extent of graphic command streams required to execute modern video games, such validators may reduce graphics rendering efficiency that result in video game content suffering from lag, frame rate drops, lower resolutions, etc. The reduced graphics rendering efficiency may drastically impact the user experience and result in low adoption of such emulation and therefore prevent more widespread adoption of video games not otherwise available on host computing device 100.

In accordance with various aspects of the techniques set forth in this disclosure, host computing device 100 may provide secure virtualization for third party GPU driver 114. Host computing device 100 may implement a shim layer that, through experimentation, validates various memory capabilities supported by the underlying graphics processing unit (GPU) and exposed by corresponding third party GPU driver 114 (where again, third party refers to graphics drivers not developed by the developer of a host operating system executed by the host computing device). This shim layer may be referred to as a “memory validator” (and shown in the example of FIG. 1 as “memory validator 145”) which spawns multiple processes in separate isolated virtual instances (possibly, virtual machines) and attempts to map memory between the multiple processes so as to accommodate various memory requirements specified for execution of standardized graphics application programming interfaces (APIs), such as OpenGL® and Vulkan®, and represented as virtual GPU drivers 144A and 144B (“virtual GPU drivers 144”).

These standardized graphics APIs may be developed for a particular hardware architecture and guest operating system 132 in which mapping of memory is not required because the hardware architecture and guest operating system 132 do not accommodate concurrent execution of applications to the same extent as host operating system 102. For example, guest operating system 132 may be developed for a smartphone, tablet, handheld gaming system, etc. and therefore may not require as much security given the controlled nature in which guest operating system 132 and underlying hardware architecture are generally optimized with respect to each other and control is dictated by the developer of guest operating system 132 and/or hardware architecture. When host computing device 100 emulates this hardware architecture for guest operating system 132 (that implements virtual GPU drivers 144) in the context of third party GPU driver 114 in which the developer of guest operating system 132 has little to no control (and thus cannot mandate support for memory mapping), mapping of memory may be difficult and thereby prevent optimized execution of applications that rely on virtual GPU drivers 144.

Memory validator 145 may alleviate some of the difficulties with mapping memory between isolated processes to identify when virtual GPU drivers 144 can be executed as isolated processes separate from emulator 120 that executes guest operating system 132. This isolation may result in more secure virtualization as virtual GPU driver 144B can be executed as a separate graphics rendering process 140 in a more restricted mode that limits the impact of malicious applications (e.g., application 133) on underlying host operating system 102 and/or host computing device 100. In this respect, memory validator 145 may identify memory mapping information (MMI) 147 supported by third party GPU driver 114 (and underlying GPU) that facilitates execution of virtual GPU driver 144B as a separate graphics rendering process having restrictions that may reduce security risks.

In operation, host OS hypervisor 104 may initiate execution of main process 120 that emulates guest operating system 132 to support execution of application 133 native to guest operating system 132. An application 133 may be “native” in the sense that application 133 is programmed according to the same hardware architecture (e.g., processing architecture, such as the ARM® architecture) for which guest OS 132 is configured for execution.

Main process 120 may interface with host OS hypervisor 104 to initiate execution of graphics rendering process 140 as a process separate from main process 120 (e.g., via a second virtual machine 105B that is distinct and separate from virtual machine 105A that executes main process 120) and therefore may have different permissions that reduce security risks for host computing device 100 and/or host operating system 102. Graphics rendering process 140 may represent a host mode graphics software stack that includes host mode (or kernel mode) virtual GPU driver 144B that conforms to the standardized graphics API and executes graphics command stream 154 (received from guest/user mode virtual GPU driver 144A) to render graphics content stored to mapped GPU memory 148A/148B (“mapped GPU memory 148”).

Responsive to initiating execution of the graphics rendering process 140, emulator 120 may execute memory validator 145 to perform a memory validation to obtain MMI 147 that identifies memory within host computing device 100 that is available for mapping between main process 120 and graphics rendering process 140. In particular, memory validator 145 may determine memory for the GPU of host computing device 100 that is available for mapping between main process 120 and graphics rendering process 140. This memory mapping is required by virtual GPU drivers 144 to enable application 133 to communicate with the underlying hardware GPU and provide texture data, shader data, image data, video data, etc.

Memory validator 145 may effectively establish a test bed for testing the particular architecture of host computing device 100 (including GPU driver 114, which may be outdated or obsolete given that users may not updated GPU driver 114 despite updates being available). Memory validator 145 may be executed each time emulator 120 is executed in preparation for execution of application 133 to render graphics content. Alternatively, memory validator 145 may be executed when emulator 120 is initiated and MMI 147 may be saved for later reference when emulator 120 is re-executed (so that memory mapping may proceed when no changes to the underlying driver/GPU hardware is detected).

Memory validator 145 may execute a first memory validation process and a second memory validation process in separate virtual machines (e.g., additional virtual machines from virtual machines 105, which are not shown in the example of FIG. 1 for ease of illustration purposes). As a result, memory validator 145 may interface with host OS hypervisor 104 to spawn two additional virtual machines 105 in which the first and second (respectively) memory validation processes execute. The first virtual memory validation process may allocate each type of the memory available for allocation according to virtual GPU drivers 144 (where some allocations may not be successful).

The first memory validation process may configure each type of the memory available for allocation for mapping between the first memory validation process and the second memory validation process. Once successfully configured (and not all types of memory may be successfully configured), the second memory validation process may write a known graphical element (e.g., a triangle having a particular color and/or texture) to each type of the memory. The first memory validation process may determine that the known graphical element is accessible by the first memory validation process for one or more of each type of the memory. Based on this iterative test of each of the types of memory that were attempted to be mapped, the first memory validation process may output the one or more types of the memory for which the graphical element is accessible to the first memory validation process as MMI 147.

These “types” of memory may refer to one or more of a device local memory (which is general memory, such as RAM), a host coherent memory, a host visible memory, and a host cached memory. Although differing by third party GPU vendor, in some instances, all memory types are device local (which may indicate the GPU has relatively fast access to these memories). Memory that is host coherent and host visible would represent memory that either is not cached by the CPU (and therefore the GPU sees the memory as it is, where CPU writes and reads tend to be relatively slow) or the GPU can directly access the CPU's caches to one degree or another. In other instances, the device local type may refer to GPU RAM, which is separate from host visible memory that refers to system RAM (e.g., CPU RAM). Further, various third party GPU vendors may implement different types for the memory that blend additional variations of the above types (in terms of which physical types of memory constitute which types of memory defined according to the standardized graphics API).

Virtual GPU drivers 144 may require, according to the standardized graphics API, host visible memory in order to enable rendering of graphics content, as host visible type memory is used for communicating various graphics information between application 133 and the underlying hardware GPU. Given the above variations for differing implementations of the standardized graphics API by different third party GPU vendors and the requirement by the standardized graphics API for a particular type of memory, memory validator 145 may operate as a shim (or, in other words, an extension of graphics rendering process 140) that identifies MMI 147 that identifies the particular physical type of memory available as the host visible type of memory for the particular GPU driver 114 (and the underlying hardware GPU).

Virtual GPU driver 144A may configure, based on MMI 147, main process 120 to support the mapping of the memory between main process 120 and graphics rendering process 140 to facilitate execution of the graphical rendering API used by application 133 for rendering graphics (which is another way of referring to graphics content). Virtual GPU driver 144 may configure main process 120 either directly (e.g., by providing MMI 147 to virtual GPU driver 144A) or indirectly via host OS hypervisor 104 (in order to make mapped GPU memory 148A available to main process 120). Virtual GPU driver 144A may also interface with virtual GPU driver 144B to configure mapped GPU memory 148B that references the same physical memory of host computing device 100 as mapped GPU memory 148A. In this way, the same physical underlying memory of host computing device 100 is “mapped” between main process 120 and graphics rendering process 140 (e.g., by way of pointers or other logical abstractions that facilitate access to the same underlying memory).

Mapping memory in this way may enable application 133 to output various graphical elements (e.g., meshes, point clouds, textures, images, video, etc.) that are required for rendering graphics to mapped GPU memory 148A. Virtual GPU driver 144B may receive graphics command stream 154 that reference mapped GPU memory 148A, but because of the memory mapping, virtual GPU driver 144B (executing as a separate and distinct graphics rendering process 140 in an isolated virtual machine 105B) may instead reference mapped GPU memory 148B to execute graphics command stream 154. In this way, the host graphics software stack may be isolated to a separate virtual machine while still maintaining the appropriate memory type that is required by the standardized graphics API.

Accordingly, the described techniques may improve operation of host computing device 100 itself. That is, host computing device 100 may, by way of executing memory validator 145, identify when graphics rendering process 140 may be executed as an isolated restricted process that potentially reduces security risks that may occur should guest operating system 132 allow execution of malicious applications. By executing graphics rendering process 140 separately, host computing device 100 may also facilitate more optimized execution (in terms of latency, computing resource utilization-such as processor cycles, GPU cycles, memory, memory bandwidth, etc., and associated power consumption) by way of potential improvements provided by the standardized graphics APIs. When memory validator 145 identifies failures with respect to required memory mapping between isolated processes, guest operating system 132 may default to execution of graphics rendering process 140 without as much isolation between guest operating system 132 and graphics rendering process (e.g., in the same virtual machine 105A), and to some extent host operating system 102/hardware, thereby still facilitating execution of application 133 (although in a more security compromised way compared to isolated execution of graphics rendering process 140).

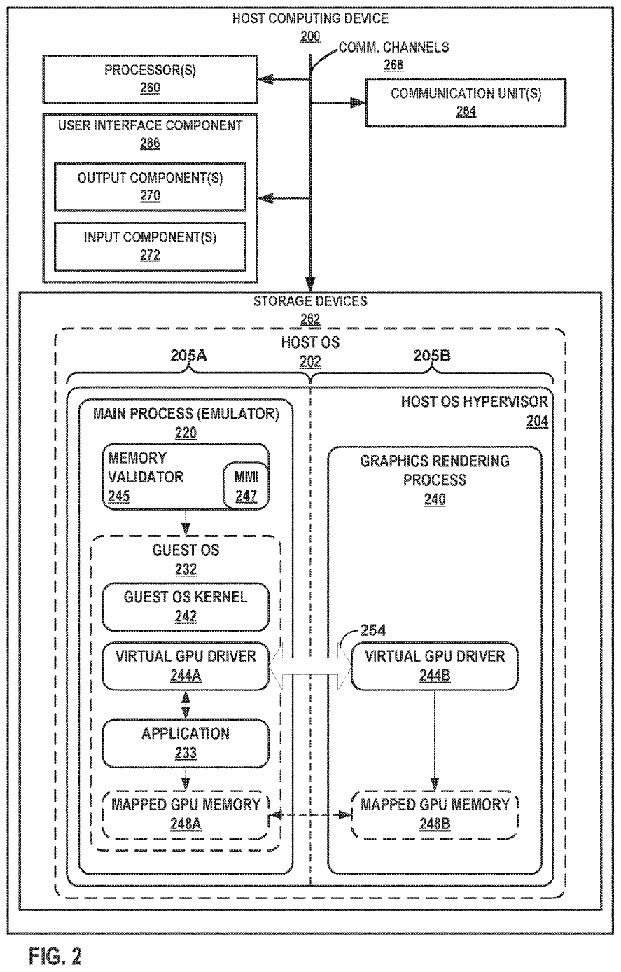

FIG. 2 is a block diagram illustrating an example host computing device that is configured to secure graphics virtualization in accordance with various aspects of the techniques described in this disclosure. FIG. 2 illustrates only one particular example of host computing device 200, and many other examples of host computing device 200 may be used in other instances and may include a subset of the components included in example host computing device 200 or may include additional components not shown in FIG. 2. Host computing device 200 may represent one example of host computing device 100 shown in the example of FIG. 1.

As shown in the example of FIG. 2, host computing device 200 includes one or more processors 260, one or more storage devices 262, one or more communication units 264, and one or more user interface components (UIC) 266, each of which are interconnected by communication channels 268. Processors 260 may implement functionality and/or execute instructions associated with host computing device 200. Examples of processors 260 include application processors, display controllers, auxiliary processors, one or more sensor hubs, and any other hardware configured to function as a processor, a processing unit, processing circuitry, or a processing device, including a CPU (which may have one or more “cores”) and the above noted GPU. In this respect, processors 260 may represent both the CPU and the GPU, which may be integrated (meaning packaged in a shared CPU/GPU chip architecture and often sharing integrated memory, buffers, memory busses, etc.) or dedicated (meaning that the GPU is separate from the CPU chip architecture and therefore does not inherently share memory, buffers, memory busses, etc.).

Storage devices 262 may represent one or more memories and/or storage devices configured to store information for processing during operation of host computing device 200. In some examples, storage devices 262 may represent a temporary memory, meaning that a primary purpose of storage devices 262 is not long-term storage. Storage devices 262 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

Storage devices 262 may, in some examples, also include one or more computer-readable storage mediums. Storage devices 262 may include one or more non-transitory computer-readable storage mediums. Storage devices 262 may be configured to store larger amounts of information than typically stored by volatile memory. Storage devices 262 may further be configured for long-term storage of information as non-volatile memory space and retain information after power on/off cycles. Examples of non-volatile memories include magnetic hard discs, optical discs, floppy discs, Flash memories, or forms of electrically programmable memories (EPROM) or electrically erasable and programmable (EEPROM) memories.

Storage devices 262 may store program instructions and/or information (e.g., data) associated with host OS 202 (which is an example of host OS 102), including host OS hypervisor 204 (shown in FIG. 2 and represents an example of host OS hypervisor 104), host OS kernel 112 (not shown in FIG. 2), third party GPU driver 114 (not shown in FIG. 2), UI module 116 (not shown in FIG. 2), and any other software capable of being executed by processors 260. Storage devices 262 may include a memory configured to store data or other information associated with host OS 202, including host OS hypervisor 204 (shown in FIG. 2 and represents an example of host OS hypervisor 104), host OS kernel 112 (not shown in FIG. 2), third party GPU driver 114 (not shown in FIG. 2), UI module 116 (not shown in FIG. 2), and any other software capable of being executed by processors 260.

Although shown as being included within host OS hypervisor 204, main process 220 (which may represent an example of main process 120) and graphics rendering process 240 (which may represent an example of graphics rendering process 140) may be stored separately, but is shown logically in the example of FIG. 2 to denote that main process 220 and graphics rendering process 240 are executed within the virtual environment provided by host OS hypervisor 204 (as described above in more detail with respect to the example of FIG. 1). Likewise, guest OS 232 (which includes guest OS kernel 242), virtual GPU drivers 244, application 233, etc. may be separately stored to storage devices 262, but again are shown logically to denote that guest OS 232 (which includes guest OS kernel 242), virtual GPU drivers 244, application 233, memory validator 245, etc. are executed as a part of different distinct processes as described above with respect to the example of FIG. 1.

Guest OS 232 (which includes guest OS kernel 242) may represent an example of guest OS 132, virtual GPU drivers 244 represent examples of virtual GPU drivers 144, application 233 represents an example of application 133, and memory validator 245 represents an example of memory validator 145. In this respect, guest OS 232 (which includes guest OS kernel 242), virtual GPU drivers 244, application 233, memory validator 245, etc. may represent similar if not the same components described above with respect to FIG. 1 but shown in the context of an example underlying hardware architecture of host computing device 200, which is, for purposes of example, assumed to conform to an x86 processing architecture (including motherboards, memory, and/or other supporting components for implementing an x86 hardware architecture required for implementing virtualization in the manner described herein).

Communication unit 264 may represent a unit configured to communicate with external devices via one or more wired and/or wireless networks by transmitting and/or receiving network signals via the one or more networks. Examples of communication units 264 include a network interface card (e.g. such as an Ethernet card), an optical transceiver, a radio frequency transceiver, a global positioning satellite (GPS) receiver, a cellular transceiver, or any other type of device that can send and/or receive data. Other examples of communication units 264 may include short wave radios, cellular data radios, wireless network radios, as well as universal serial bus (USB) controllers.

UIC 266 may be implemented using various technologies. For instance, UIC 266 may function as an input device using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. As further shown in the example of FIG. 2, UIC 266 may include one or more input components 270 and one or more output components 272.

One or more input components 270 of host computing device 200 may receive an input. Examples of inputs are tactile, audio, and video input. Input components 270, in one example, includes a presence-sensitive input device (e.g., a touch sensitive screen, a presence-sensitive display), mouse, keyboard, voice responsive system, video camera, microphone or any other type of device for detecting input from a human or machine. In some examples, input components 270 may include one or more sensor components such as one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 272 of host computing device 200 may generate output. Examples of output are tactile, audio, and video output. Output components 272 of host computing device 200, in one example, includes a PSD, sound card, video graphics adapter card, speaker, cathode ray tube (CRT) monitor, liquid crystal display (LCD), or any other type of device for generating output to a human or machine.

While illustrated as an internal component of host computing device 200, UIC 266 may also represent an external component that shares a data path with computing device 200 for transmitting and/or receiving input and output. For instance, in one example, UIC 266 represents a built-in component of host computing device 200 located within and physically connected to the external packaging of host computing device 200 (e.g., a display on a mobile phone). In another example, UIC 266 represents an external component of computing device 200 located outside and physically separated from the packaging or housing of host computing device 200 (e.g., a monitor, a projector, etc. that shares a wired and/or wireless data path with host computing device 200).

Host OS hypervisor 204 may initiate execution of main process 220 that emulates guest OS 232 to support execution of application 233 native to guest OS 232. An application 233 may be “native” in the sense that application 233 is programmed according to the same hardware architecture (e.g., processing architecture, such as the ARM® architecture) for which guest OS 232 is configured for execution.

Main process 220 may interface with host OS hypervisor 204 to initiate execution of graphics rendering process 240 as a process separate from main process 220 (e.g., via a second virtual machine 205B that is distinct and separate from virtual machine 205A that executes main process 220) and therefore may have different permissions that reduce security risks for host computing device 200 and/or host operating system 202. Graphics rendering process 240 may represent a host mode graphics software stack that includes host mode (or kernel mode) virtual GPU driver 244B that conforms to the standardized graphics API and executes graphics command stream 254 (received from guest/user mode virtual GPU driver 144A) to render graphics content stored to mapped GPU memory 248A/248B (“mapped GPU memory 248”).

Responsive to initiating execution of the graphics rendering process 240, emulator 120 may execute memory validator 245 to perform a memory validation to obtain MMI 247 that identifies memory within host computing device 200 that is available for mapping between main process 220 and graphics rendering process 240. In particular, memory validator 245 may determine memory for the GPU of host computing device 200 that is available for mapping between main process 220 and graphics rendering process 240. This memory mapping is required by virtual GPU drivers 244 to enable application 233 to communicate with the underlying hardware GPU and provide texture data, shader data, image data, video data, etc.

Memory validator 245 may effectively establish a test bed for testing the particular architecture of host computing device 200 (including GPU driver 114 shown in FIG. 1, which may be outdated or obsolete given that users may not updated GPU driver 114 despite updates being available). Memory validator 245 may execute each time graphics rendering process 240 is spawned in preparation for execution of application 233 to render graphics content.

Memory validator 245 may execute a first memory validation process and a second memory validation process in potentially separate virtual machines (e.g., additional virtual machines from virtual machines 205, which are not shown in the example of FIG. 2 for ease of illustration purposes). Although discussed as being in separate virtual machines, memory validator 245 may execute the first and second memory validation processes in a single virtual machine (or, in other words, the same virtual machine), For separate virtual machines, memory validator 245 may interface with host OS hypervisor 204 to spawn two additional virtual machines 205 in which the first and second (respectively) memory validation processes execute. The first virtual memory validation process may allocate each type of the memory available for allocation according to virtual GPU drivers 244 (where some allocations may not be successful).

The first memory validation process may configure each type of the memory available for allocation for mapping between the first memory validation process and the second memory validation process. Once successfully configured (and not all types of memory may be successfully configured), the second memory validation process may write a known graphical element (e.g., a triangle having a particular color and/or texture) to each type of the memory. The first memory validation process may determine that the known graphical element is accessible by the first memory validation process for one or more of each type of the memory. Based on this iterative test of each of the types of memory that were attempted to be mapped, the first memory validation process may output the one or more types of the memory for which the graphical element is accessible to the first memory validation process as MMI 247.

While described as the first memory validation process configuring each type of the memory available for allocation for mapping between the first memory validation process and the second memory validation process, memory validator 245 may spawn the first memory validation process and the second memory validation process to test a single one of the types of memory available for allocation for mapping. Memory validator 245 may spawn another instance of the first memory validation process and the second memory validation process to test another type of the memory available for allocation for mapping. Memory validator 245 may continue to spawn instances of the first and second memory validation processes iteratively to test each type of the memory available for allocation for mapping or may spawn the instances of the first and second memory validation process concurrently for testing each different type of the memory available for allocation for mapping (e.g., meaning if there are three types of memory available for allocation for mapping, memory validator 245 may concurrently spawn three first memory validation processes and three second memory validation process to test the three types of memory).

Separate instances of the first and second memory validation processes for each type of the memory available for allocation for mapping may allow different instances of the first and second memory validation processes to fail (or, in other words, crash), which may occur for some third party GPU drivers 214. In this way, the separate instances of the first and second memory validation processes may fail for a particular type of the memory available for allocation for mapping without impacting other instances of the first and second memory validation processes that are testing different types of the memory available for allocation for mapping. As such, the separate instances may validate mapping of different types of memory in a potentially more secure way that resolves to some configuration without potentially taking down the orchestration process.

These “types” of memory may refer to a device local memory (which is general memory, such as RAM), a host coherent memory, a host visible memory, and/or a host cached memory. Although differing by third party GPU vendor, in some instances, all memory types are device local (which may indicate the GPU has relatively fast access to these memories). Memory that is host coherent and host visible would represent memory that either is not cached by the CPU (and therefore the GPU sees the memory as it is, where CPU writes and reads tend to be relatively slow) or the GPU can directly access the CPU's caches to one degree or another. In other instances, the device local type may refer to GPU RAM, which is separate from host visible memory that refers to system RAM (e.g., CPU RAM). Further, various third party GPU vendors may implement different types for the memory that blend additional variations of the above types (in terms of which physical types of memory constitute which types of memory defined according to the standardized graphics API).

As such, memory validator 245 may perform the memory validation to determine one or more types of memory within host computing device 200 that is available for mapping between main process 220 and graphics rendering process 240. These types of memory, as noted above, may conform to the graphical rendering API provided by way of virtual GPU drivers 244.

Virtual GPU drivers 244 may require, according to the standardized graphics API, host visible memory in order to enable rendering of graphics content, as host visible type memory is used for communicating various graphics information between application 233 and the underlying hardware GPU. Given the above variations for differing implementations of the standardized graphics API by different third party GPU vendors and the requirement by the standardized graphics API for a particular type of memory, memory validator 245 may operate as a shim (or, in other words, an extension of graphics rendering process 240) that identifies MMI 247 that identifies the particular physical type of memory available as the host visible type of memory for the particular GPU driver 214 (and the underlying hardware GPU).

Virtual GPU driver 244A may configure, based on MMI 247, main process 220 to support the mapping of the memory between main process 220 and graphics rendering process 240 to facilitate execution of the graphical rendering API used by application 233 for rendering graphics (which is another way of referring to graphics content). Virtual GPU driver 244A may configure main process 220 either directly (e.g., by providing MMI 247 to virtual GPU driver 244A) or indirectly via host OS hypervisor 204 (in order to make mapped GPU memory 248A available to main process 220). Virtual GPU driver 244A may also interface with virtual GPU driver 244B to configure mapped GPU memory 248B that references the same physical memory of host computing device 200 as mapped GPU memory 248A. In this way, the same physical underlying memory of host computing device 200 is “mapped” between main process 220 and graphics rendering process 240 (e.g., by way of pointers or other logical abstractions that facilitate access to the same underlying memory).

Mapping memory in this way may enable application 233 to output various graphical elements (e.g., meshes, point clouds, textures, images, video, etc.) that are required for rendering graphics to mapped GPU memory 248A. Virtual GPU driver 244B may receive graphics command stream 254 that reference mapped GPU memory 248A, but because of the memory mapping, virtual GPU driver 244B (executing as a separate and distinct graphics rendering process 240 in an isolated virtual machine 205B) may instead reference mapped GPU memory 248B to execute graphics command stream 254. In this way, the host graphics software stack may be isolated to a separate virtual machine while still maintaining the appropriate memory type that is required by the standardized graphics API.

In other words, virtual GPU drivers 244 may expose the standardized graphics API that does not natively support sandboxing (e.g., secure isolation) of graphics rendering process 240 (e.g., the kernel mode aspect of the graphics software stack) as the memory that used to be in main process 220 is now in graphics rendering process 240 and cannot be accessed by main process 220. This may break the standardized graphics API requirement that a mappable memory type exist. To resolve this failure to meet the standardized graphics API requirement, memory needs to be exported from graphics rendering process 240 and imported into main process 220 (and then mapped).

As such, upon launch of main process 220 (and then graphics rendering process 240), virtual machine 205B executes memory validator 245 that attempts memory mapping across processes for every memory type reported by virtual GPU driver 244B. Memory validator 245 may attempt this memory mapping by creating another virtual GPU driver instance (in a separate process within a separate virtual machine) and another instance of itself (meaning memory validator 245 but with more arguments for inter-process communication-IPC). Memory is created, exported in the first process, and imported in the other process, where after mapping the memory on both ends, memory validator 245 writes data in one process and reads it in the other to ensure writes are visible. If a memory type passes this test, memory validator 245 marks the memory type as usable in MMI 247 and returns MMI 247 over IPC to main process 220.

In addition to memory mapping in the manner described above, virtual GPU driver 244B (which may be referred to as the downstream virtual GPU driver) may perform memory filtering in which virtual GPU driver 244B may modify what memory virtual GPU driver 244A identifies as available by overriding the standardized graphics API calls. For example, when a memory type of host visible and failed memory validation (or in other words, checking), virtual GPU drivers 244 may not support this memory type across processes. Virtual GPU driver 244B may therefore remove the host visible flag for the corresponding memory that failed the memory validation from a properties file when virtual GPU driver 244A requests this properties file. As such, virtual GPU driver 244A may use this type but not map this memory type.

As noted above, third party GPU vendors may support the standardized graphics API in different ways. In some instances, a third party GPU vendor may configure third party GPU drivers to signal a memory type that is both device local and host visible, which may complicate the cross-process mapping described above as such cross-process mapping may result in an out of memory error. In this instance, memory validator 245 may mark all such types of memory as failing the test (regardless of the actual outcome of the cross-process mapping test described above), so that virtual GPU drivers 244 do not utilize this memory type.

The third party GPU vendor may, in some instances, configure third party GPU drivers to inadvertently result in failures of cross-process memory importing to fail. In other instances, a third party GPU vendor may develop third party GPU drivers that fail to map imported memory entirely. In these two instances, graphics rendering process 240 may interface with host OS hypervisor 204 to import host OS memory as GPU memory 248, which essentially bypasses virtual GPU drivers 244 for memory mapping.

The sequence for utilizing these various workarounds may be defined as follows:
1) Is there any memory type that is shareable via standard Vulkan extensions? (e.g., VK_KHR_external memory, and various platform specific extensions such as VK_KHR_external_memory_win32 and VK_KHR_external_memory_fd)->Use standard VK external memory;
2) Is there any memory type that is shareable via VK_EXT_external_memory_host?->Use workaround external (e.g., host OS) memory
3) Are there any more fixes to be done? (e.g., memory filtering)->Apply final fixes
4) If sandboxing is not supported, inform the main process to not attempt it. Otherwise, return a configuration (MMI 247) containing a mask of memory types that can be used and the algorithm (standard-using virtual GPU driver memory mapping; or workaround using host OS memory mapping).

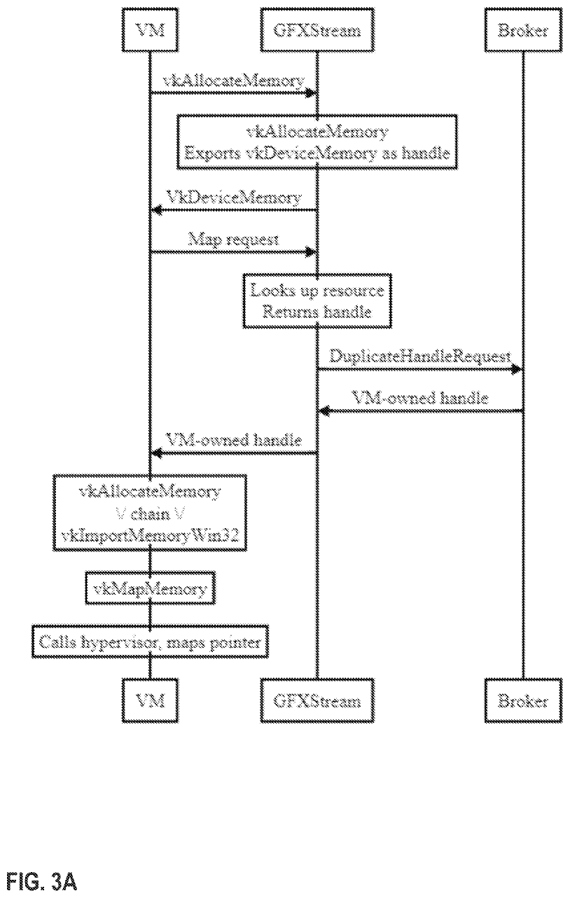

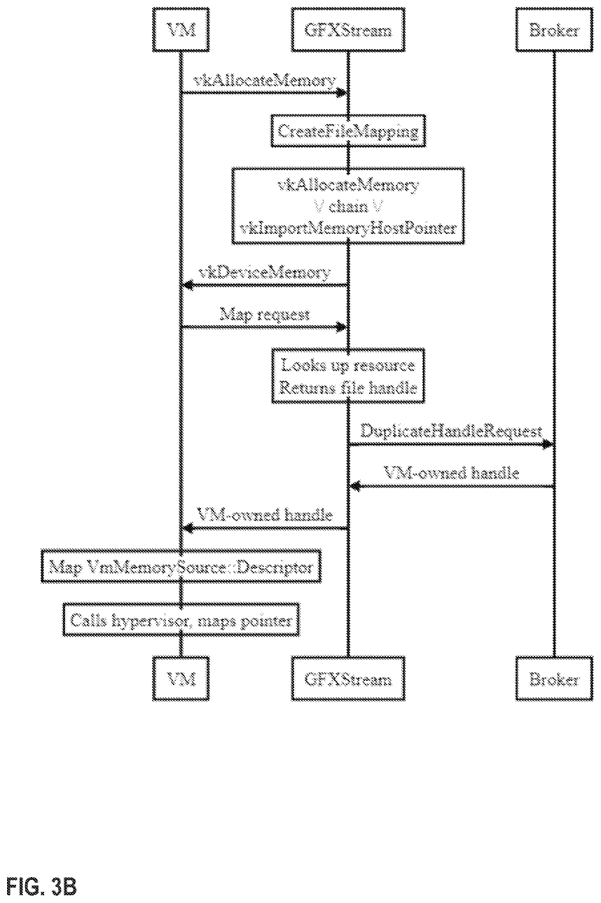

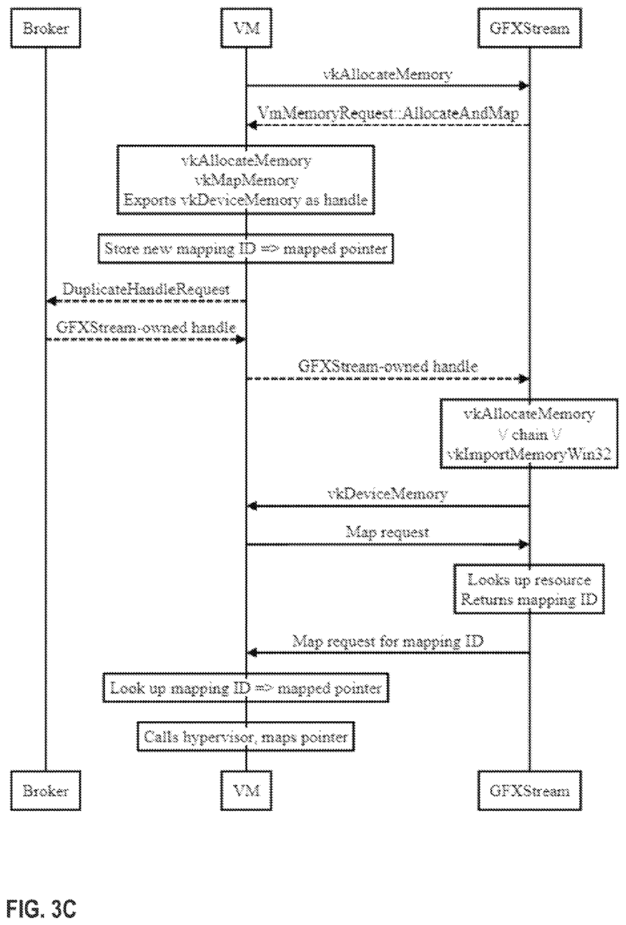

FIGS. 3A-3C are flowcharts illustrating various examples of how memory mapping may occur in support of the secure virtualization techniques described in this disclosure. In the examples of FIGS. 3A and 3B, it is assumed that virtual GPU drivers 244 represent Vulkan® (Vk) GPU drivers, where VM refers to emulator 220 (which is another way to refer to main process 220), and GFXStream refers to graphics rendering process 240.

Referring first to the example of FIG. 3A, the broker process is used to duplicate handles safely (implicitly through the Tube abstraction), so the GFXStream process does not have the ability to access the main process. The “broker” is a process that has the permission to share OS resources between other processes (which cannot be done since such processes are sandboxed). In order to share the handle, emulator 220 uses an abstraction referred to as the Tube, which serializes data and handles between processes. The tube supports a feature where the Broker processes the request to share a handle from process A to process B. This way, the exported memory handle can be shared between processes, without granting sharing capability to the individual processes.

Also creating memory and importing memory use the same function: vkAllocateMemory. The arguments (passed via struct chains to function vkAllocateMemory) determine the operation. In this instance, vkAllocateMemory is used in the VM process to create a VkDeviceMemory alias for the memory in the GPU process, which is then mapped to the host and then mapped via the hypervisor to the guest. Guest writes will end up affecting the same buffer, in the GFXStream process, achieving the desired HOST VISIBLE allocation across processes.

In the example of FIG. 3B, VK_EXT_external_memory_host is an extension that when enabled allows Vulkan to import arbitrary host pointers as VkDeviceMemory. A standard CreateFileMapping is used to share across processes, and import it as Vulkan memory on the GPU process.

In the example of FIG. 3C, instead of allocating memory in the GPU process, memory is allocated in the VM process. Then, export the memory from the VM and import in the GPU. This way, the vkMapMemory call happens in the VM process, which created the memory, and may not result in crashes for instances where exporting memory into the GPU crashes. It looks like the flowchart shown in FIG. 3C, with the dotted lines meaning a secondary IPC channel that we use to send the memory creation request to the VM process when potentially needed.

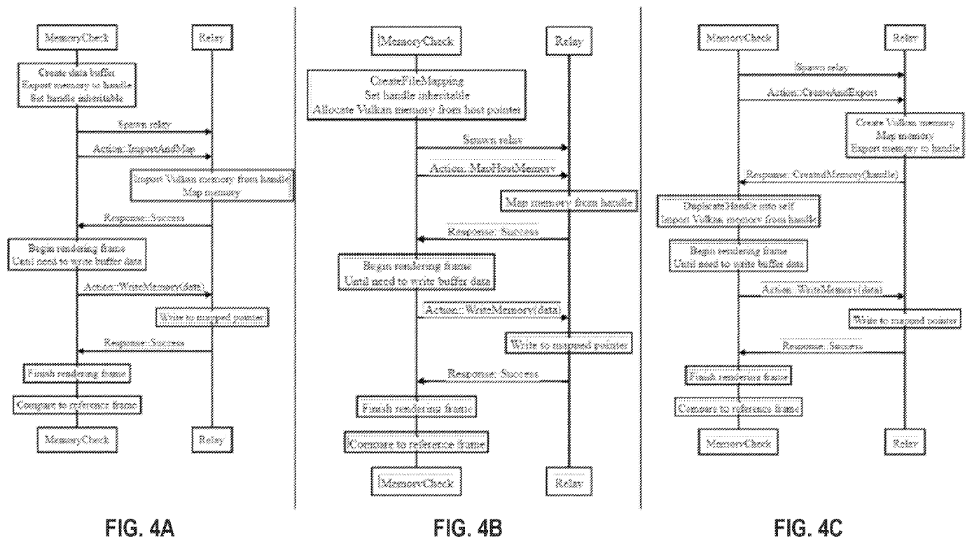

FIGS. 4A-4C are flowcharts illustrating example operation of memory validator in supporting various aspects of the secure virtualization techniques described in this disclosure. Memory validator 245 may effectively implement each version of the memory allocation described above with respect to the examples of FIGS. 3A-3C in order to identify which memory types are available for mapping between processes (e.g., in this instance memory validator 245, which is shown as “MemoryCheck” and a separate relay process). MemoryCheck renders a standard multi-colored triangle using Vulkan.

MemoryCheck may set up the entire graphics pipeline, which roughly does the following:
1. Create data buffer containing triangle vertices' position and color.
2. Set up graphics pipeline, using bundled shaders that render a triangle.
3. Render to a VkImage. This is offscreen rendering, no window or swapchain is used.
4. Copy the VkImage to a buffer, and the buffer to host RAM, to get the render results.

MemoryCheck tests if a given memory type will work for external memory, instead of filling in the data in step 1, MemoryCheck may ask a “relay” process to import the exported memory (from MemoryCheck) and write the data itself. In this simulation, the relay is the VM (emulator 220), importing the memory and writing to it from the guest.

If the external memory write was not seen by graphics rendering process 240, the triangle would not show up. Similarly, MemoryCheck can detect any Vulkan errors thrown throughout the process and declare the type invalid.

Memory Check may compare the output frame to the reference rendered at the beginning for the given memory type. This way, even if there are platform differences in the resulting triangle, it may not matter. MemoryCheck may only identify a difference from the reference frame that we rendered the same way on the same device, so there is no need to bundle a triangle image. In some instances, MemoryCheck may identify such a device, which did not clear the background to black on an older driver, but managed to pass the checker since the resulting images are the same. This may highlight the point, as MemoryCheck does not care about the correctness of the image, just that the image is unmodified when we swap memory types. FIGS. 4A-4C provide example schemes for how memory check simulates the mentioned sharing.

An alternate MemoryCheck process may include the following:
1. Process 1 creates a buffer backed by memory;
2. Process 2 imports the backing memory and maps the backing memory;
3. Process 2 writes data to the memory;
4. Process 1 issues a GPU command to read the buffer into a secondary buffer
5. Process 1 verifies the secondary buffer contains the correct memory

This alternate MemoryCheck process may avoid the graphics pipeline creation, at the cost of potentially missing invalid behavior.

At the end of its diagnosis run, MemoryCheck may output the following summary, capturing all devices and memory types on the system (which is an example of MMI 247):

[{
// UUID of the device tested
“uuid”:[33,223,252,201,77,100,227,235,26,109,149,133,253,39,34,124],
// Method that was chosen
“method”:“Standard”,
// Types that can be HOST_VISIBLE for the guest
“allowed_types”:[2,3,4]
}, {
“uuid”:[134,128,96,154,1,0,0,0,0,0,0,0,0,0,0,0],
“method”:“Standard”,
“allowed_types”:[1,2]
}]

Each entry may link a device on the system (by uuid) to a suggested memory sharing algorithm (e.g., standard as shown in FIG. 4A, host as shown in FIG. 4B, and reverse as shown in FIG. 4C), and types which passed the render test. So at a high level, MemoryCheck may effectively emulate an extension that identifies which memory types are external. MemoryCheck may go one step further, because MemoryCheck may also support the esoteric sharing methods ‘Host’ and ‘Reversed’, which unlocks sandboxing on various GPU hardware.

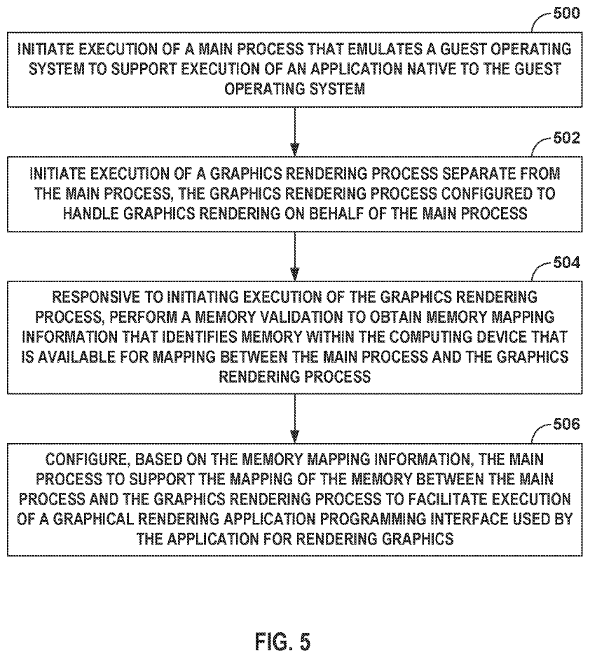

FIG. 5 is a flowchart illustrating example operation of host computing device in performing various aspects of the secure virtualization techniques described in this disclosure. As described above, host OS hypervisor 104 may initiate execution of main process 120 that emulates guest operating system 132 to support execution of application 133 native to guest operating system 132 (500). Main process 120 may interface with host OS hypervisor 104 to initiate execution of graphics rendering process 140 as a process separate from main process 120 (e.g., via a second virtual machine 105B that is distinct and separate from virtual machine 105A that executes main process 120) and therefore may have different permissions that reduce security risks for host computing device 100 and/or host operating system 102 (502). Graphics rendering process 140 may represent a host mode graphics software stack that includes host mode (or kernel mode) virtual GPU driver 144B that conforms to the standardized graphics API and executes graphics command stream 154 (received from guest/user mode virtual GPU driver 144A) to render graphics content stored to mapped GPU memory 148A/148B (“mapped GPU memory 148”).

Responsive to initiating execution of the graphics rendering process 140, emulator 120 may execute memory validator 145 to perform a memory validation to obtain MMI 147 that identifies memory within host computing device 100 that is available for mapping between main process 120 and graphics rendering process 140 (504). In particular, memory validator 145 may determine memory for the GPU of host computing device 100 that is available for mapping between main process 120 and graphics rendering process 140. This memory mapping is required by virtual GPU drivers 144 to enable application 133 to communicate with the underlying hardware GPU and provide texture data, shader data, image data, video data, etc.

Virtual GPU driver 144B may configure, based on MMI 147, main process 120 to support the mapping of the memory between main process 120 and graphics rendering process 140 to facilitate execution of the graphical rendering API used by application 133 for rendering graphics (which is another way of referring to graphics content) (506). Virtual GPU driver 144A may configure main process 120 either directly (e.g., by providing MMI 147 to virtual GPU driver 144A) or indirectly via host OS hypervisor 104 (in order to make mapped GPU memory 148A available to main process 120). Virtual GPU driver 144A may also interface with virtual GPU driver 144B to configure mapped GPU memory 148B that references the same physical memory of host computing device 100 as mapped GPU memory 148A. In this way, the same physical underlying memory of host computing device 100 is “mapped” between main process 120 and graphics rendering process 140 (e.g., by way of pointers or other logical abstractions that facilitate access to the same underlying memory).

Mapping memory in this way may enable application 133 to output various graphical elements (e.g., meshes, point clouds, textures, images, video, etc.) that are required for rendering graphics to mapped GPU memory 148A. Virtual GPU driver 144B may receive graphics command stream 154 that reference mapped GPU memory 148A, but because of the memory mapping, virtual GPU driver 144B (executing as a separate and distinct graphics rendering process 140 in an isolated virtual machine 105B) may instead reference mapped GPU memory 148B to execute graphics command stream 154. In this way, the host graphics software stack may be isolated to a separate virtual machine while still maintaining the appropriate memory type that is required by the standardized graphics API.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various aspects of the disclosure have been described. These and other aspects are within the scope of the following claims.

1: A method comprising:
initiating, by a host operating system executed by a computing device, execution of a main process that emulates a guest operating system to support execution of an application native to the guest operating system;
initiating, by the main process, execution of a graphics rendering process separate from the main process, the graphics rendering process configured to handle graphics rendering on behalf of the main process;
responsive to initiating execution of the graphics rendering process, performing, by the main process, a memory validation to obtain memory mapping information that identifies memory within the computing device that is available for mapping between the main process and the graphics rendering process; and
configuring, based on the memory mapping information, the main process to support the mapping of the memory between the main process and the graphics rendering process to facilitate execution of a graphical rendering application programming interface used by the application for rendering graphics.

2: The method of claim 1, wherein the application native to the guest operating system is not natively executable by the host operating system.

3: The method of claim 1,
wherein performing the memory validation comprises determining one or more types of memory within the computing device that is available for mapping between the main process and the graphics rendering process, and
wherein the one or more types of memory conform to the graphical rendering application programming interface.

4: The method of claim 3, wherein at least one of the one or more types of the memory that conforms to the graphical rendering application programming interface is required to be successfully mapped in order to execute the graphics rendering process separately from the main process.

5: The method of claim 4, wherein the type of memory required to be successfully mapped in order to execute the graphics rendering process is a host visible type in which the guest operating system is able to access the type of memory for purposes of rendering the graphics by the application via the main process.

6: The method of claim 1, wherein performing the memory validation comprises:
executing a first memory validation process and a second memory validation process;
allocating, by the first memory validation process, each type of the memory available for allocation according to the graphical rendering application programming interface;
configuring each type of the memory available for allocation for mapping between the first memory validation process and the second memory validation process;
writing, by the second memory validation process, a known graphical element or buffer to each type of the memory;
determining, by the first memory validation process, that the known graphical element or buffer is accessible by the first memory validation process for one or more of each type of the memory; and
outputting the one or more types of the memory for which the graphical element or buffer is accessible to the first memory validation process as the memory mapping information.

7: The method of claim 6,
wherein each type of the memory conforms to the graphical rendering application programming interface,
wherein at least one of type of the memory that conforms to the graphical rendering application programming interface is required to be successfully mapped in order to execute the graphics rendering process separately from the main process, and
wherein the at least one type of memory required to be successfully mapped in order to execute the graphics rendering process is a host visible type in which the guest operating system is able to access the type of memory for purposes of rendering the graphics by the application via the main process.

8: The method of claim 1, wherein performing the memory validation comprises interfacing with a third-party graphics driver that facilitate hardware level interactions with a graphics processing unit of the computing device, the third-party graphics driver being developed by a third party entity different from a first party entity that developed the guest operating system.

9: The method of claim 1, wherein the host operating system has a different architecture than the guest operating system.

10: The method of claim 1, wherein the application comprises a video game application.

11: A computing device comprising:
a memory configured to store a host operating system; and
processing circuitry configured to:
execute the host operating system, which is configured to initiate execution of a main process that emulates a guest operating system to support execution of an application native to the guest operating system,
wherein the main process is configured to:
initiate execution of a graphics rendering process separate from the main process, the graphics rendering process configured to handle graphics rendering on behalf of the main process;
responsive to initiating execution of the graphics rendering process, perform a memory validation to obtain memory mapping information that identifies memory within the computing device that is available for mapping between the main process and the graphics rendering process; and
configure the main process to support the mapping of the memory between the main process and the graphics rendering process to facilitate execution of a graphical rendering application programming interface used by the application for rendering graphics.

12: The computing device of claim 11, wherein the application native to the guest operating system is not natively executable by the host operating system.

13: The computing device of claim 11,
wherein the main process is, when configured to perform the memory validation, configured to determine one or more types of memory within the computing device that is available for mapping between the main process and the graphics rendering process, and
wherein the one or more types of memory conform to the graphical rendering application programming interface.

14: The computing device of claim 13, wherein at least one of the one or more types of the memory that conforms to the graphical rendering application programming interface is required to be successfully mapped in order to execute the graphics rendering process separately from the main process.

15: The computing device of claim 14, wherein the type of memory required to be successfully mapped in order to execute the graphics rendering process is a host visible type in which the guest operating system is able to access the type of memory for purposes of rendering the graphics by the application via the main process.

16: The computing device of claim 11,
wherein the main process is, when configured to perform the memory validation, is configured to execute a first memory validation process and a second memory validation process,
wherein the first memory validation process is configured to:
allocate each type of the memory available for allocation according to the graphical rendering application programming interface; and
configure each type of the memory available for allocation for mapping between the first memory validation process and the second memory validation process;
wherein the second memory validation process is configured to write a known graphical element or buffer to each type of the memory, and
wherein the first memory validation process is further configured to:
determine that the known graphical element or buffer is accessible by the first memory validation process for one or more of each type of the memory; and
output the one or more types of the memory for which the graphical element or buffer is accessible to the first memory validation process as the memory mapping information.

17: The computing device of claim 16,
wherein each type of the memory conforms to the graphical rendering application programming interface,
wherein at least one of type of the memory that conforms to the graphical rendering application programming interface is required to be successfully mapped in order to execute the graphics rendering process separately from the main process, and
wherein the at least one type of memory required to be successfully mapped in order to execute the graphics rendering process is a host visible type in which the guest operating system is able to access the type of memory for purposes of rendering the graphics by the application via the main process.

18: The computing device of claim 11, wherein the main process is, when configured to perform the memory validation, is configured to interface with a third-party graphics driver that facilitate hardware level interactions with a graphics processing unit of the computing device, the third-party graphics driver being developed by a third party entity different from a first party entity that developed the guest operating system.

19: The computing device of claim 11, wherein the host operating system has a different architecture than the guest operating system.

20: A non-transitory computer-readable storage medium having instructions stored thereon that, when executed, cause one or more processors to:
execute a host operating system, which is configured to initiate execution of a main process that emulates a guest operating system to support execution of an application native to the guest operating system,
wherein the main process is configured to:
initiate execution of a graphics rendering process separate from the main process, the graphics rendering process configured to handle graphics rendering on behalf of the main process;
responsive to initiating execution of the graphics rendering process, perform a memory validation to obtain memory mapping information that identifies memory within the computing device that is available for mapping between the main process and the graphics rendering process; and
configure the main process to support the mapping of the memory between the main process and the graphics rendering process to facilitate execution of a graphical rendering application programming interface used by the application for rendering graphics.
